(19) United States
(12) Patent Application Publication
(10) Pub. No.: US 2023/0091419 A1
(43) Pub. Date: Mar. 23, 2023

(54) PROGRAMMABLE LOGIC CONTROLLER

(71) Applicant: Edwards Limited, Burgess Hill, West Sussex (GB)

(72) Inventor: Peter Reginald Crundwell, Burgess Hill, Sussex (GB)

(21) Appl. No.: 17/905,375

(22) PCT Filed: Feb. 24, 2021
(86) PCT No.: PCT/GB2021/050450

§ 371 Date: Aug. 31, 2022

(30) Foreign Application Priority Data
Mar. 3, 2020 (GB) 2003041.7

(51) Int. Cl. G05B 19/05

(52) U.S. Cl. CPC G05B 19/056; G05B 2219/13004; G05B 2219/2605

(57) ABSTRACT

A programmable logic controller, PLC, comprising: a programmable logic module; a Modbus interface configured to receive one or more Modbus commands, the one or more Modbus commands specifying a configuration for one or more Boolean logic operations; and a programming module operatively coupled to the Modbus interface and the programmable logic module, the programming module being configured to program the programmable logic module in accordance with the configuration for the one or more Boolean logic operations specified by the received one or more Modbus commands.

### CROSS-REFERENCE TO RELATED APPLICATION

This application is a Section 371 National Stage Application of International Application No. PCT/GB2021/050450, filed Feb. 24, 2021, and published as WO 2021/176198A1 on Sep. 10, 2021, the content of which is hereby incorporated by reference in its entirety and which claims priority of British Application No. 2003041.7, filed Mar. 3, 2020.

### FIELD

The present invention relates to programmable logic controller(s).

### BACKGROUND

The Modbus protocol is a well-known communication protocol used for transmitting information between electronic devices. The Modbus protocol is described on the World Wide Web, for example at http://www.modbus.org which is incorporated herein by reference along with all related web pages. The Modbus Protocol specification is described in “MODBUS application protocol specification v1.1b3”, which is incorporated herein by reference. Reference information for software developers implementing the Modbus messaging service can be found in “MODBUS Messaging on TCP/IP Implementation Guide V1.0b”, which is incorporated herein by reference. Implementation of the Modbus protocol over serial line is described in “MODBUS over serial line specification and implementation guide V1.02”, which is incorporated herein by reference.

The Modbus protocol is commonly used for communicating between factory equipment and industrial electronic devices, such as programmable logic controllers (PLC), interconnected by, for example, local area networks (LAN).

PLCs are industrial digital computers which are typically connected to industrial equipment to control and/or monitor said equipment in accordance with stored programs. PLCs typically provide for highly reliable control, and ease of programming and process fault diagnosis.

The discussion above is merely provided for general background information and is not intended to be used as an aid in determining the scope of the claimed subject matter. The claimed subject matter is not limited to implementations that solve any or all disadvantages noted in the background.

### SUMMARY

In a first aspect, the present invention provides a programmable logic controller, PLC. The PLC comprises a programmable logic module, a Modbus interface configured to receive one or more Modbus communications or commands, the one or more Modbus communications or commands specifying a configuration for one or more Boolean logic operations; and a programming module operatively coupled to the Modbus interface and the programmable logic module, the programming module being configured to program the programmable logic module in accordance with the configuration for the one or more Boolean logic operations specified by the received one or more Modbus communications or commands.

The one or more Modbus communications or commands may be messages that are in accordance with a Modbus-type protocol. The one or more Modbus communications or commands may be messages that are encapsulated in a Modbus-type protocol. The Modbus-type protocol may be selected from the group consisting of Modbus RTU, Modbus TCP/IP, Modbus TCP, Modbus over TCP/IP, or Modbus over TCP, Modbus RTU/IP, Modbus over UDP, Modbus Plus (Modbus+, MB+ or MBP), Pemex Modbus, and Enron Modbus. Advantageously, this aspect tends to be implementable with any Modbus protocol or Modbus-type protocol including but not limited those listed previously.

The PLC may further comprise one or more PLC inputs. The PLC may further comprise one or more PLC outputs.

One or more first Modbus commands may specify a first Boolean logic operation, and a first input for the first Boolean logic operation. The one or more first Modbus commands may be configured to specify the first Boolean logic operation by setting a first Modbus register to a first value, and specify the first input by setting a second Modbus register to a second value. The one or more first Modbus commands may further specify a second input for the first Boolean logic operation. The first Boolean logic operation may be a logic operation selected from the group consisting of FALSE, OR, AND, XOR, NOR, NAND, XNOR, and TRUE. The PLC may be configured to output, for use by a device remote from the PLC, an output of the first Boolean logic operation. The one or more first Modbus commands may specify that the first input for the first Boolean logic operation is a value received a first PLC input of the one or more PLC inputs. The one or more first Modbus commands may specify that the first input for the first Boolean logic operation is an output of a second Boolean logic operation. The one or more first Modbus commands may specify that the first input for the first Boolean logic operation is an inverted input. The one or more Modbus commands may specify that an output of the first Boolean logic operation is a value output at a first PLC output of the one or more PLC outputs.

The programmed operation of the PLC may comprise monitoring and/or controlling a system of apparatus remote from the PLC.

The Modbus interface may be configured to receive the one or more Modbus commands from a device remote from the PLC.

In a further aspect, the present invention provides a system comprising a PLC in accordance with any preceding aspect, and a device remote from the PLC and configured to transmit the one or more Modbus commands to the Modbus interface of the PLC.

In a further aspect, the present invention provides a method for programming operation of a programmable logic controller, PLC. The PLC comprises a programmable logic module. The method comprises receiving, by a Modbus interface of the PLC, one or more Modbus communications or commands, the one or more Modbus communications or commands specifying a configuration for one or more Boolean logic operations, and programming, by a programming module of the PLC, operation of the programmable logic module in accordance with the configuration for the one or more Boolean logic operations specified by the received one or more Modbus communications or commands.

The method may further comprise receiving, by a device remote from the PLC, a user input, generating, by the device remote from the PLC, using the user input, the one or more Modbus communications or commands. This may, for example, include encapsulating one or more communications or commands in a Modbus-type protocol. The method may further include transmitting, by the device remote from the PLC, to the Modbus interface, the one or more Modbus communications or commands in accordance with the Modbus protocol.

The method may further comprise at least one of monitoring, by the PLC, a system or apparatus, or controlling, by the PLC, a system or apparatus. The system or apparatus may be remote from the PLC.

In a further aspect, the present invention provides a program or plurality of programs arranged such that when executed by a computer system or one or more processors it/they cause the computer system or the one or more processors to: receive one or more Modbus communications or commands, the one or more Modbus communications or commands specifying a configuration for one or more Boolean logic operations; and program operation of a programmable logic controller, PLC, in accordance with the configuration for the one or more Boolean logic operations.

In a further aspect, the present invention provides a machine-readable storage medium storing a program or at least one of the plurality of programs according to any preceding aspect.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic illustration (not to scale) of a process water system;

FIG. 2 is a schematic illustration (not to scale) showing a monitoring system for use with the process water system;

FIG. 3 is a process flow chart of a process of programming a programmable logic controller of the monitoring system, and monitoring the process water system; and

FIG. 4 is a schematic illustration (not to scale) showing the monitoring system including the programmed programmable logic controller.

### DETAILED DESCRIPTION

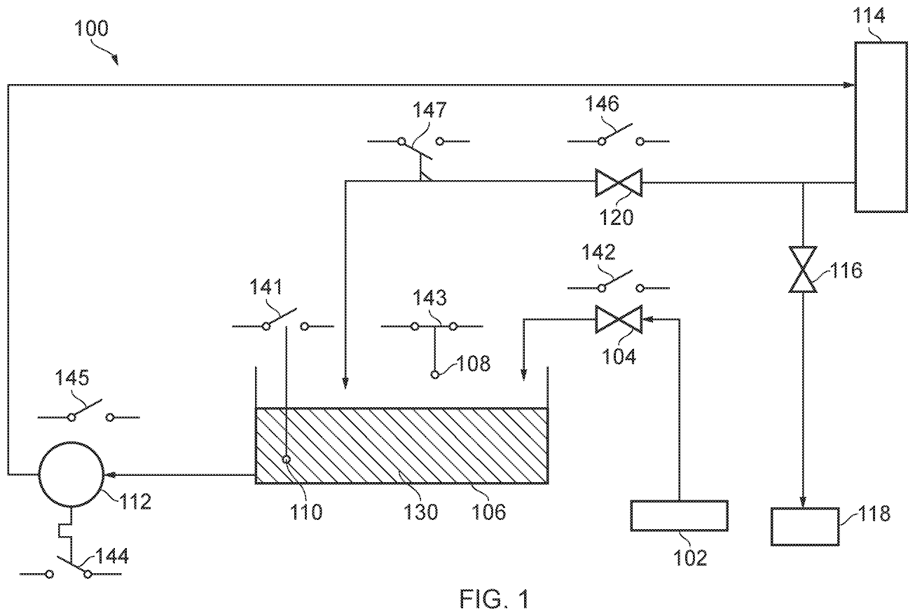

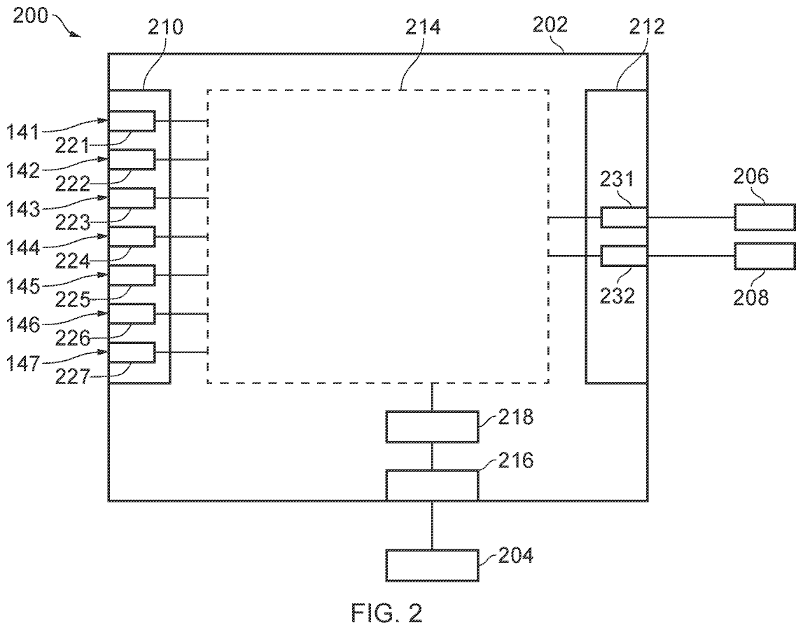

FIG. 1 is a schematic illustration (not to scale) of an example system useful in understanding the present invention. The system is a process water system 100 that is to be controlled by a programmable logic controller (PLC), an embodiment of which is described in more detail later below with reference to FIGS. 2 to 4.

In this example, the process water system 100 comprises a process water source 102, a fill valve 104, a storage tank 106, a first water level sensor 108, a second water level sensor 110, a pump 112, a process module 114, a drain valve 116, a drain 118, and a return valve 120.

The process water source 102 is configured to supply process water to the storage tank 106 via the fill valve 104. The fill valve 104 controls the supply of process water to the storage tank 106 from the process water source 102.

The storage tank 106 is configured to store process water received from the process water source 102.

The first water level sensor 108 is located within the storage tank 106. The first water level sensor 108 is configured to sense when the water level within the storage tank 106 is at or above a first threshold level. In this example, the first threshold level corresponds to a “maximum allowed water level”.

The second water level sensor 110 is located within the storage tank 106. The second water level sensor 110 is configured to sense when the water level within the storage tank 106 is below a second threshold level. In this example, the second threshold level corresponds to a “minimum allowed water level”.

The storage tank 106 is further coupled to the pump 112. The pump 112 is configured to pump process water from the storage tank 106 to the process module 114.

The process module 114 is configured to use the process water pumped to it by the pump 122 to perform a process. The process performed by the process module 114 using the process water may be any appropriate process including, but not limited to, a cooling process in which the process water is used as a coolant, a cleaning process, a fabrication process, a dilution process, etc.

The process module 114 is further coupled to the drain 118 via the drain valve 116. Process water (i.e. unused process water, or process water that has been used by the process module 114) may be drained or removed from the system 100 via the drain 118. The drain valve 116 controls the flow of process water to the drain 118 from the process module 114.

The process module 114 is further coupled to the storage tank 106 via the return valve 120. The return valve 120 controls the flow of process water to the storage tank 106 from the process module 114. In this way, process water (i.e. unused process water, or process water that has been used by the process module 114) may be returned to the storage tank to be reused or recycled.

In this example, the process water system 100 further comprises a plurality of switches, namely a first switch 141, a second switch 142, a third switch 143, a fourth switch 144, a fifth switch 145, a sixth switch 146, and a seventh switch 147.

The first switch 141 is operatively coupled to the second water level sensor 110. The first switch 141 is configured to be closed if the second water level sensor 110 senses that the water level within the storage tank 106 is below the second threshold level. The first switch 141 is configured to output a digital output of TRUE (binary 1) when the first switch 141 is closed, i.e. when the water level is below the minimum allowed water level. The first switch 141 is further configured to be open if the second water level sensor 110 senses that the water level within the storage tank 106 is at or above the second threshold level. The first switch 141 is further configured to output a digital output of FALSE (binary 0) when the first switch 141 is open, i.e. when the water level is at or above the minimum allowed water level.

The second switch 142 is operatively coupled to the fill valve 104. The second switch 142 is configured to be closed if the fill valve 104 is closed, i.e. if the fill valve 104 prevents the flow of process water from the process water source 102 to the storage tank 106. The second switch 142 is configured to output a digital output of TRUE (binary 1) when the second switch 142 is closed, i.e. when the fill valve 104 is closed. The second switch 142 is further configured to be open if the fill valve 104 is open, i.e. if the fill valve 104 permits the flow of process water from the process water source 102 to the storage tank 106. The second switch 142 is further configured to output a digital output of FALSE (binary 0) when the second switch 142 is open, i.e. the fill valve 104 is open.

The third switch 143 is operatively coupled to the first water level sensor 108. The third switch 143 is configured to be closed if the second water level sensor 110 senses that the water level within the storage tank 106 is below the first threshold level. The third switch 143 is configured to output a digital output of TRUE (binary 1) when the third switch 143 is closed, i.e. when the water level is below the maximum allowed water level. The third switch 143 is further configured to be open if the first water level sensor 108 senses that the water level within the storage tank 106 is at or above the first threshold level. The third switch 143 is further configured to output a digital output of FALSE (binary 0) when the third switch 143 is open, i.e. when the water level is at or above the maximum allowed water level.

The fourth switch 144 is operatively coupled to the pump 112. More specifically, the fourth switch 144 is coupled to a temperature sensor coupled to (e.g. mounted on) the pump 112. The temperature sensor is configured to measure a temperature of the pump 112. The fourth switch 144 is configured to be closed if the temperature of the pump 112, as measured by the temperature sensor, is at or above a threshold temperature (corresponding to a “maximum allowed pump temperature), i.e. if the pump 112 is “too hot”. The fourth switch 144 is configured to output a digital output of TRUE (binary 1) when the fourth switch 144 is closed, i.e. when the pump temperature is at or above the threshold temperature. The fourth switch 144 is further configured to be open if the temperature of the pump 112, as measured by the temperature sensor, is below the threshold temperature, i.e. if the pump 112 is not “too hot”. The fourth switch 144 is further configured to output a digital output of FALSE (binary 0) when the pump temperature is below the threshold temperature.

The fifth switch 145 is operatively coupled to the pump 112. The fifth switch 145 is configured to be closed if the pump 112 is ON, i.e. if the pump 112 is running so as to pump process water from the storage tank 106. The fifth switch 145 is configured to output a digital output of TRUE (binary 1) when the fifth switch 145 is closed, i.e. when the pump 112 is ON. The fifth switch 145 is further configured to be open if the pump 112 is OFF, i.e. such that process water is not pumped from the storage tank 116. The fifth switch 145 is further configured to output a digital output of FALSE (binary 0) when the fifth switch 145 is open, i.e. the pump 112 is OFF.

The sixth switch 146 is operatively coupled to the return valve 120. The sixth switch 146 is configured to be closed if the return valve 120 is closed, i.e. if the return valve 120 prevents the flow of process water from the process module 114 to the storage tank 106. The sixth switch 146 is configured to output a digital output of TRUE (binary 1) when the sixth switch 146 is closed, i.e. when the return valve 120 is closed. The sixth switch 146 is further configured to be open if the return valve 120 is open, i.e. if the return valve 120 permits the flow of process water from the process module 114 to the storage tank 106. The sixth switch 146 is further configured to output a digital output of FALSE (binary 0) when the sixth switch 146 is open, i.e. the return valve 120 is open.

The seventh switch 147 is operatively coupled to a conduit connecting the return valve 120 to the storage tank 106. More specifically, the seventh switch 147 is coupled to a flow sensor configured to detect the flow of process water within the conduit connecting the return valve 120 to the storage tank 106. The seventh switch 147 is configured to be closed if the flow sensor detects that water is flowing along the conduit connecting the return valve 120 to the storage tank 106. The seventh switch 147 is configured to output a digital output of TRUE (binary 1) when the seventh switch 147 is closed, i.e. when the flow of water from the process module 114 to the storage tank 106 is detected. The seventh switch 147 is further configured to be open if the flow sensor does not detect that water is flowing along the conduit connecting the return valve 120 to the storage tank 106. The seventh switch 147 is further configured to output a digital output of FALSE (binary 0) when the seventh switch 147 is open, i.e. when no flow of water from the process module 114 to the storage tank 106 is detected.

FIG. 2 is a schematic illustration (not to scale) showing a monitoring system 200 for monitoring the process water system 100 in accordance with an embodiment.

In this embodiment, the monitoring system 200 comprises a PLC 202, a user device 204, a first fault indicator 206, and a second fault indicator 208.

The PLC 202 comprises an input connector 210, an output connector 212, a programmable logic module 214, a Modbus interface 216, and a programming module 218.

The input connector 210 comprises a plurality of inputs which may be input pins. Specifically, the input connector 210 comprises a first input 221, a second input 222, a third input 223, a fourth input 224, a fifth input 225, a sixth input 226, and a seventh input 217.

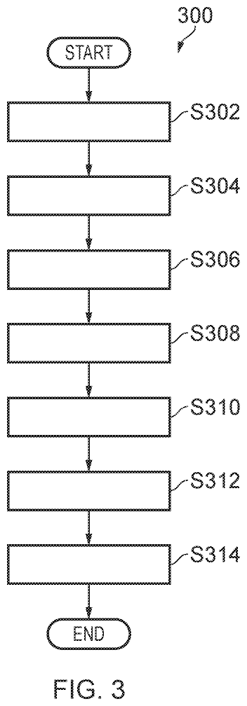

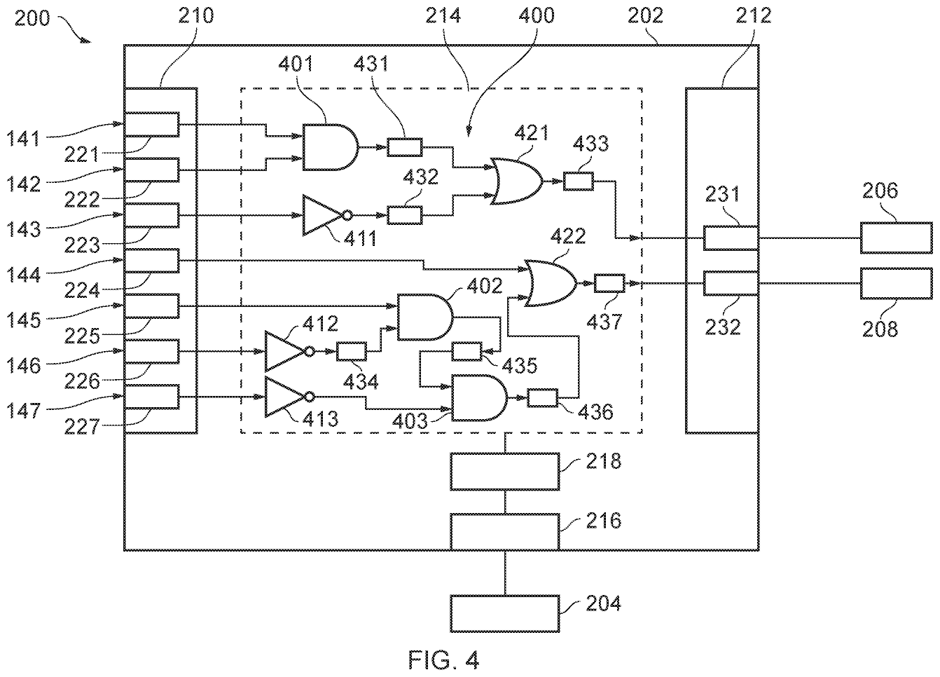

In this embodiment, the PLC 202 is operatively coupled to the process water system 100 to enable the monitoring system 200 to monitor the process water system 100, as described in more detail later below with reference to FIGS. 3 and 4. More specifically, in this embodiment, the first input 221 is connected (via wireless or wired connection) to the first switch 141 such that, in operation, an output of the first switch 141 is received at the first input 221. Similarly, the second input 222 is connected (via wireless or wired connection) to the second switch 142 such that, in operation, an output of the second switch 142 is received at the second input 222. Similarly, the third input 223 is connected (via wireless or wired connection) to the third switch 143 such that, in operation, an output of the third switch 143 is received at the third input 223. Similarly, the fourth input 224 is connected (via wireless or wired connection) to the fourth switch 144 such that, in operation, an output of the fourth switch 144 is received at the fourth input 224. Similarly, the fifth input 225 is connected (via wireless or wired connection) to the fifth switch 145 such that, in operation, an output of the fifth switch 145 is received at the fifth input 225. Similarly, the sixth input 226 is connected (via wireless or wired connection) to the sixth switch 146 such that, in operation, an output of the sixth switch 146 is received at the sixth input 226. Similarly, the seventh input 227 is connected (via wireless or wired connection) to the seventh switch 147 such that, in operation, an output of the seventh switch 147 is received at the seventh input 227.

The input connector 210 is connected to the programmable logic module 214. Specifically, each of the inputs 221-227 of the input connector 210 is connected to the programmable logic module 214 such that signals received at the inputs 221-227 may be sent to the programmable logic module 214.

The output connector 212 comprises a plurality of outputs which may be output pins. Specifically, the output connector 212 comprises a first output 231 and a second output 232.

The output connector 212 is connected to the programmable logic module 214. Specifically, each of the outputs 231-232 of the output connector 212 is connected to the programmable logic module 214, and each output is configured to receive a respective output of the programmable logic module 214.

Each of the outputs 231-232 of the output connector 212 is further connected to a respective fault indicator. Specifically, the first output 231 is coupled to the first fault indicator 206, and the second output 232 is coupled to the second fault indicator 208.

The programmable logic module 214 is coupled between the input connector 210 and the output connector 212. The programmable logic module 214 is configured to, in operation, receive a one or more input signals from the inputs 221-227 of the input connector 210, to process those input signals, and to output one or more output signals to the outputs 231-232 of the output connector 212. The processing of the received input signals by the programmable logic module 214 depends on the programming or configuration of the programmable logic module 214. The programmable logic module 214 may be programmed (or reprogrammed) as described in more detail later below with reference to FIG. 3, by the user device 204 sending or uploading program instructions or signals to the programmable logic module 214 via the Modbus interface 216 and the programming module 218.

The Modbus interface 216 is an input device of the PLC 202. The Modbus interface 216 is operatively coupled to the user device 204 via a communications link. This communications link is a bi-directional communications link. This communications link may be a wired or wireless communications link. Examples of appropriate communications link between the Modbus interface 216 and the user device 204 include, but are not limited to, an Internet protocol (IP) communications link and a Transmission Control Protocol (TCP) communications link. The Modbus interface 216 is configured to, in operation, receive one or more communications in accordance with a Modbus-type protocol (i.e. Modbus-type communications or commands) from the user device 204. In other words, the Modbus interface 216 is configured to, in operation, receive one or more messages encapsulated in a Modbus-type protocol. The Modbus-type protocol may be any Modus-type protocol selected from the group of Modbus-type protocol including, but not limited to, Modbus RTU, Modbus TCP/IP, Modbus TCP, Modbus over TCP/IP, or Modbus over TCP, Modbus RTU/IP, Modbus over UDP, Modbus Plus (Modbus+, MB+ or MBP), Pemex Modbus, Enron Modbus, etc.

The Modbus interface 216 is further coupled to the programming module 218 such that Modbus communications or commands received by the Modbus interface 216 are sent to the programming module 218. The Modbus interface 216 may be configured to convert received Modbus communications or commands into a format that is useable or understandable by the programming module 218.

The programming module 218 is configured to process the communications it receives from the Modbus interface 216 (i.e. the Modbus communications or commands, or the formatted Modbus communications or commands), and to program or configured the programmable logic module 214 in accordance with the received communications. In particular, in this embodiment, as described in more detail later below with reference to FIGS. 3 and 4, the communications from the user device 204 comprises one or more Modbus commands that specify a plurality of Boolean logic operators or functions, and a configuration or arrangement for those Boolean logic operators. The programming module 218 is configured to implement those Modbus commands to program or configure the programmable logic module 214 in accordance with the Boolean logic operators and the configuration thereof. In particular, the programming module 218 may program the programmable logic module 214 such that, in effect, the inputs 221-227 are connected to the outputs 231-232 via an arrangement or network of Boolean logic operators, as specified in the Modbus communications.

The user device 204 may be any appropriate electronic communication device, for example, a computer such as a tablet computer, a laptop, or a smartphone. The user device 204 is a device using which a user can send Modbus communications to the Modbus interface 216 of the PLC 202.

In this embodiment, the programmable logic module 214, the programming module 218, the Modbus interface 216, and the user device 204 are further configured such that outputs, properties, or characteristics of the programming module 218 (such as the below-described Coils) may be sent from the programmable logic module 214 to the user device 204. This information received by the user device 204 may be displayed on the user device 204 to a user.

The first fault indicator 206 may be any appropriate output device configured to provide an indication that a fault has occurred in the process water system 100. The first fault indicator 206 is coupled to the first output 231 such that, in operation, the first fault indicator 206 receives an output of the PLC 202 from the first output 231. In this embodiment, the first fault indicator 206 is configured to indicate that a fault with the process water system 100 has occurred in response to receiving a digital output of TRUE (binary 1) from the first output 231. Also, the first fault indicator 206 is configured to indicate that a fault with the process water system 100 has not occurred in response to receiving a digital output of FALSE (binary 0) from the first output 231.

The second fault indicator 208 may be any appropriate output device configured to provide an indication that a fault has occurred in the process water system 100. The second fault indicator 208 is coupled to the second output 232 such that, in operation, the second fault indicator 208 receives an output of the PLC 202 from the second output 232. In this embodiment, the second fault indicator 208 is configured to indicate that a fault with the process water system 100 has occurred in response to receiving a digital output of TRUE (binary 1) from the second output 232. Also, the second fault indicator 208 is configured to indicate that a fault with the process water system 100 has not occurred in response to receiving a digital output of FALSE (binary 0) from the second output 232.

The first and second fault indicators 206, 208 may comprise any appropriate type of indicator, such as one or more indicators selected from the group of indicators consisting of: visible warnings such as lights (e.g. flashing lights) or a message displayed on a screen, and audible warnings such an audible alarm.

Preferably, the first and second fault indicators 206, 208 are different types of fault indicators. The first and second fault indicators 206, 208 may indicate faults of different severity. For example, the first fault indicator 206 may indicate a relatively low-severity fault, while the second fault indicator 208 may indicate a relatively high-severity fault.

Apparatus, including the PLC 202, for implementing the above arrangement, and performing the method steps to be described later below, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

FIG. 3 is a process flow chart of a process 300 of programming the PLC 202 of the monitoring system 200, and of monitoring the process water system 100.

It should be noted that certain of the process steps depicted in the flowchart of FIG. 3 and described below may be omitted or such process steps may be performed in differing order to that presented below and shown in FIG. 3. Furthermore, although all the process steps have, for convenience and ease of understanding, been depicted as discrete temporally-sequential steps, nevertheless some of the process steps may in fact be performed simultaneously or at least overlapping to some extent temporally.

At step s302, the process water system 100 is provided.

At step s304, the PLC 202 is coupled to the process water system 100. In particular, each of the inputs 221-227 of the PLC 202 is coupled to a respective switch 141-147 of the system 100, as described in more detail earlier above with reference to FIGS. 1 and 2.

At step s306, the user controls the user device 204 to formulate one or more messages or communications for programming or configuring the PLC 202.

In this embodiment, the messages or communications are in accordance with a Modbus protocol. In other words, the messages or communications are encapsulated in a Modbus-type protocol (for example, Modbus RTU, Modbus TCP/IP, Modbus TCP, Modbus over TCP/IP, or Modbus over TCP, Modbus RTU/IP, Modbus over UDP, Modbus Plus (Modbus+, MB+ or MBP), Pemex Modbus, Enron Modbus, etc.). In this embodiment, the one or more messages or communications comprise one or more Modbus commands for use by a Modbus device (i.e. the PLC 202).

In this embodiment, one or more of the messages specifies a Boolean logic operation and one or more inputs for that Boolean logic operation. The Boolean logic operation may be specified by a Modbus command that instructs a Modbus device to write a value associated with that particular Boolean operation to a Holding Register associated with Boolean operation selection. An input for a Boolean logic operation may be specified by a Modbus command that instructs a Modbus device to write a value associated with that particular input to a Holding Register associated with Boolean operator input.

By way of example:
Holding Registers corresponding with first inputs for Boolean operators may be identified by identifiers HR1₀, HR1₁, HR1₂, HR1₃, and so on.
Holding Registers corresponding with second inputs for Boolean operators may be identified by identifiers HR2₀, HR2₁, HR2₂, HR2₃, and so on.
Holding Registers corresponding with Boolean operators may be identified by identifiers HR3₀, HR3₁, HR3₂, HR3₃, and so on.
For inputs to Boolean operators:
   Raw inputs may be identified by identifiers RI₁, RI₂, RI₃, and so on. I.e., in this embodiment, the raw input received at the first input 221 from the first switch 141 (which is a binary value 0 or 1) is identified by the identifier RI₁; similarly, the raw input received at the second input 222 from the second switch 142 is identified by the identifier RI₂; similarly, the raw input received at the third input 223 from the third switch 143 is identified by the identifier RI₃; and so on.
   Inverted raw inputs may be identified by identifiers Inv₁, Inv₂, Inv₃, and so on. An inverted raw input is the alternative binary value to the raw input, i.e. if a raw input is a 1, then the inverted input is a 0, and vice versa. In this embodiment, the inversion of the raw input RI₁ is identified by the identifier Inv₁; similarly, the inversion of the raw input RI₂ is identified by the identifier Inv₂; similarly, the inversion of the raw input RI₃ is identified by the identifier Inv₃; and so on. Advantageously, specifying inverted raw inputs in this way tends to reduce or eliminate a need for NOT logic operators to be separately specified in the Modbus commands used to program the programmable logic module 214. Thus, communication bandwidth between the user device 204 and the PLC 202 tends to be reduced.
   Processed inputs, i.e. inputs that are outputs from earlier Boolean operators, i.e. that are not raw inputs, are identified by identifiers Pr₁, Pr₂, Pr₃, and so on. For example, the output of a first Boolean operator (i.e. a first processed input) may be identified by the identifier Pr₁; similarly, the output of a second Boolean operator may be identified by the identifier Pr₂; similarly, the output of a third Boolean operator may be identified by the identifier Pr₃; and so on.
For Boolean operators, different Boolean operators are identified by identifiers B₀, B₁, B₂, B₃, and so on. In this embodiment, identifier “B₀” is assigned to operator “FALSE”, identifier “B₁” is assigned to operator “OR”, identifier “B₂” is assigned to operator “AND”, identifier “B₃” is assigned to operator “XOR”, identifier “B₄” is assigned to operator “NOR”, identifier “B₅” is assigned to operator “NAND”, identifier “B₆” is assigned to operator “XNOR”, and identifier “B₇” is assigned to operator “TRUE”.

Thus, by way of example, a first Boolean operator may be a two input AND that receives as its inputs raw input values from the first and second inputs 221, 22. This first Boolean operator may be specified in a message that comprises the following Modbus commands:

| | Holding Register | Value | Comments |
|---|---|---|---|
| First input | HR1₀ | RI₁ | This specifies the |
| selection | | | first input as the |
| | | | raw input received |
| | | | at input 221 |
| Second input | HR2₀ | RI₂ | This specifies the |
| selection | | | second input as |
| | | | the raw input |
| | | | received at input |
| | | | 222 |
| Boolean operation | HR3₀ | B₂ | This identifies the |
| selection | | | Boolean operation |
| | | | as “AND” |

The output of this first Boolean operator may be assigned the value Pr₁, which may be used in subsequent Modbus commands.

In this embodiment, the one or more messages for programming the PLC 202 created by the user using the user device 104 are as follows:

| | | Holding | | |
|---|---|---|---|---|
| | | Register | Value | Comments |
| First | First input | HR1₀ | RI₁ | Raw input |
| Boolean | selection | | | received at |
| operation | | | | input 221 |
| | Second input | HR2₀ | RI₂ | Raw input |
| | selection | | | received at |
| | | | | input 222 |
| | Boolean | HR3₀ | B₂ | AND |
| | operation | | | |
| | selection | | | |
| Second | First input | HR1₁ | Pr₁ | Output of first |
| Boolean | selection | | | Boolean |
| operation | | | | operation |
| | Second input | HR2₁ | Inv₃ | Inversion of |
| | selection | | | input received |
| | | | | at input 223 |
| | Boolean | HR3₁ | B₁ | OR |
| | operation | | | |
| | selection | | | |
| | Write value Pr₂ to the first output 231. | | | |
| Third | First input | HR1₂ | RI₅ | Raw input |
| Boolean | selection | | | received at |
| operation | | | | input 225 |
| | Second input | HR2₂ | lnv₆ | Inversion of |
| | selection | | | input received |
| | | | | at input 226 |
| | Boolean | HR3₂ | B₂ | AND |
| | operation | | | |
| | selection | | | |
| Fourth | First input | HR1₃ | Pr₃ | Output of third |
| Boolean | selection | | | Boolean |
| operation | | | | operation |
| | Second input | HR2₃ | Inv₇ | Inversion of |
| | selection | | | input received |
| | | | | at input 7 |
| | Boolean | HR3₃ | B₂ | AND |
| | operation | | | |
| | selection | | | |
| Fifth | First input | HR₄ | RI₄ | Raw input |
| Boolean | selection | | | received at |
| operation | | | | input 224 |
| | Second input | HR2₄ | Pr₄ | Output of fourth |
| | selection | | | Boolean |
| | | | | operation |
| | Boolean | HR3₄ | B₁ | OR |
| | operation | | | |
| | selection | | | |

Write value Pr₅ to the second output 232

Modbus Holding Registers (e.g. HR4₁) may be used to connect the outputs from the Boolean operations (logic gates) to the physical output pins 231, 232. For example, if a particular numerical value is written to a Holding Register HR4₁ then the output from the second Boolean operation will be connected to the first output 231. Also for example, if a particular numerical value is written to a Holding Register HR4₂ then the output from the fifth Boolean operation will be connected to the second output 232.

At step s308, the user device 204 sends the formulated one or more messages, comprising the Modbus commands, to the Modbus interface 216 of the PLC 202.

At step s310, the Modbus interface 216 receives the one or more messages and forwards said messages to the programming module 218. The Modbus interface 216 may format or convert the one or more messages to be in a format that is useable by the programming module 218.

At step s312, the programming module 218 programs or configures the programmable logic module 214 in accordance with the received messages, i.e. using the received Modbus commands. Thus, the programming module 218 may be considered to couple, in software, the inputs 221-227 to the outputs 231-232 via Boolean operators, as specified in the received Modbus commands. Conceptually, it may be considered that the programming module 218 constructs a Boolean network between the inputs 221-227 to the outputs 231-232, the Boolean network being as specified by the received Modbus commands.

FIG. 4 is a schematic illustration (not to scale) showing the programmable logic module 214 as programmed by the programming module 218.

In this embodiment, the programmable logic module 214 is programmed in accordance with the above-described Modbus commands to specify a Boolean network connecting together the inputs 221-227 and the outputs 231-232.

In this embodiment, the Boolean network 400 comprises a plurality of AND operators 401, 402, 403, a plurality of NOT operators 411, 412, 413, and a plurality of OR operators 421, 422. The Boolean network 400 further comprises a plurality of Coils 431, 432, 433, 434, 435, 436, 437.

A first AND operator 401 receives, as its inputs, raw data values RI₁, RI₂ from the first and second inputs 221, 222. The first AND operator 401 outputs an output value Pr₁ to a first Coil 431.

A first NOT operator 411 receives, as its input, a raw data value RI₃ from the third input 223. An output of the first NOT operator 411, i.e. the inverted value Inv₃, is output to a second Coil 432.

A first OR operator 421 receives, as its inputs, data values Pr₁ and Inv₃ stored in the first Coil 431 and the second Coil 432 respectively. The first OR operator 421 outputs an output value Pr₂ to a third Coil 433.

The first output 231 receives the output value Pr₂ from the third Coil 433.

A second NOT operator 412 receives, as its input, a raw data value RI₆ from the sixth input 226. An output of the second NOT operator 412, i.e. the inverted value Inv₆, is output to a fourth Coil 434.

A second AND operator 402 receives, as its inputs, a raw data value RI₅ from the fifth input 225, and the data value Inv₆ in the fourth Coil 434. The second AND operator 402 outputs an output value Pr₃ to a fifth Coil 435.

A third NOT operator 413 receives, as its input, a raw data value RI₇ from the seventh input 227.

A third AND operator 403 receives, as its inputs, the data value Pr₃ in the fifth Coil 435, and the inverted value Inv₇ output by the third NOT operator 413. The third AND operator 402 outputs an output value Pr₄ to a sixth Coil 436.

A second OR operator 422 receives, as its inputs, a raw data value RI₄ from the fourth input 224, and a data value Pr₄ stored in the sixth Coil 436. The second OR operator 422 outputs an output value Pr₅ to a seventh Coil 437.

The second output 232 receives the output value Pr₅ from the seventh Coil 433.

Thus, the PLC 202 is programmed.

Returning now the description of the process 300 of FIG. 3, the monitoring system, including the programmed PLC 202, monitors the process water system 100. In particular, the PLC 202 receive signals from the switches 141-147 at its inputs 221-227. These input signals are processed by the PLC 214 using the Boolean logic network 400 to provide output signals to the outputs 231-232. PLC 202 provides output signals to the first and second fault indicators 206, 208 via the first and second outputs 231, 232 respectively. The first and second fault indicators 206, 208 provide an indication of a fault or otherwise.

By way of example, if a FALSE (binary 0) signal is received from the third switch 142 (this signal corresponding to the water level in the storage tank 106 being at or above the maximum allowed water level), a TRUE (binary 1) signal would be output to the second Coil 432 and received as an input at the first OR operator 421. Thus, a TRUE (binary 1) signal would be output to the third Coil 433. The TRUE (binary 1) signal would be sent to the first fault indicator 206 via the first output 231. The first fault indicator 206 would indicate the presence of a (e.g. low severity) fault.

Also for example, if a TRUE (binary 1) signal is received from the fourth switch 144 (this signal corresponding to the pump 112 having a temperature exceeding a threshold), a TRUE (binary 1) signal would be received as an input at the second OR operator 422. Thus, a TRUE (binary 1) signal would be output to the seventh Coil 437. The TRUE (binary 1) signal would be sent to the second fault indicator 208 via the second output 232. The second fault indicator 208 would indicate the presence of a (e.g. high severity) fault.

A user may take an appropriate remedial action in response to a fault being indicated at either or both of the fault indicators 206, 208.

Thus, a process of programming a PLC and monitoring a system is provided.

Advantageously, the PLC 202 is configured to output values stored in one or more of the Coils 431-437 to the user device 204, via the Modbus interface 216. The received information can be displayed on the user device 104 to the user. The user tends to be able to use the displayed Coil information to, for example, discern a more precise cause of a fault indication.

The above-described system and method tends to be advantageously simple. For example, a user tends to be capable of programming the PLC using simple logic-based commands, and tends not to need software programming knowledge.

The above-described system and method tends to reduce the likelihood of errors and crashes of the PLC occurring.

In the above embodiments, the PLC is used to monitor a process water system. However, in other embodiments, instead of or in addition to monitoring, the PLC is used to control the process water system, e.g. to control operation of one or more of the valves or the pump. In other embodiments, the PLC is used to control and/or monitor a different system other than the process water system. Examples of appropriate alternative systems include, but are not limited to, packaging machines, wind turbines, solar installations, building automation, robotics, machine tools, assembly lines, and lighting systems.

In the above embodiments, the PLC provides outputs to fault indicators. However, in other embodiments one or both of the fault indicators may be omitted, or one or more additional fault indicators may be included. In other embodiments, the PLC provides an output to a different type of output device instead of or in addition to the fault indicator(s). for example, in some embodiments, the PLC may provide an output signal to a control device that controls the system based on the received signal from the PLC.

In the above embodiments, the PLC receives inputs from seven switches. However, in other embodiments, the PLC receives inputs from a different number of switches. In other embodiments, the PLC receives inputs from one or more different types of input device other than a switch, instead of or in addition to one or more of the switches.

In the above embodiments, the PLC receives digital binary inputs. However, in other embodiments the PLC receives a different type of input, e.g. an input that is not binary and/or not digital. In some embodiments, the received non-binary and/or non-digital inputs may be converted into a digital and/or binary input. For example, in some embodiments, an input device may provide an analog signal to the PLC. The PLC (or other device) may convert the received analog input to a binary input, for example by providing a binary level of “1” if the analog signal is at or above a given threshold, or providing a binary level of “0” if the analog signal is below the given threshold.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A programmable logic controller, PLC, comprising:
a programmable logic module;
a Modbus interface configured to receive one or more Modbus commands, the one or more Modbus commands specifying a configuration for one or more Boolean logic operations; and
a programming module operatively coupled to the Modbus interface and the programmable logic module, the programming module being configured to program the programmable logic module in accordance with the configuration for the one or more Boolean logic operations specified by the received one or more Modbus commands.

2. The PLC according to claim 1, wherein the PLC further comprises one or more PLC inputs and one or more PLC outputs.

3. The PLC according to claim 1, wherein the received one or more Modbus commands comprise one or more first Modbus commands which specify:
a first Boolean logic operation; and
a first input for the first Boolean logic operation.

4. The PLC according to claim 3, wherein the one or more first Modbus commands are configured to:
specify the first Boolean logic operation by setting a first Modbus register to a first value; and
specify the first input by setting a second Modbus register to a second value.

5. The PLC according to claim 3, wherein the one or more first Modbus commands further specify a second input for the first Boolean logic operation.

6. The PLC according to claim 3, wherein the first Boolean logic operation is a logic operation selected from the group consisting of FALSE, OR, AND, XOR, NOR, NAND, XNOR, and TRUE.

7. The PLC according to claim 3, wherein the PLC is configured to output, for use by a device remote from the PLC, an output of the first Boolean logic operation.

8. The PLC according to claim 3, wherein the PLC further comprises one or more PLC inputs and one or more PLC outputs and wherein the one or more first Modbus commands specify that the first input for the first Boolean logic operation is a value received at a first PLC input of the one or more PLC inputs.

9. The PLC according to claim 3, wherein the PLC further comprises one or more PLC inputs and one or more PLC outputs and wherein the one or more first Modbus commands specify that the first input for the first Boolean logic operation is an output of a second Boolean logic operation.

10. The PLC according to claim 3, wherein the one or more first Modbus commands specify that the first input for the first Boolean logic operation is an inverted input.

11. The PLC according to claim 3, wherein the one or more Modbus commands specify that an output of the first Boolean logic operation is a value output at a first PLC output of the one or more PLC outputs.

12. The PLC according to claim 1, wherein the programmed operation of the PLC comprises monitoring and/or controlling a system or apparatus remote from the PLC.

13. The PLC according to claim 1, wherein the Modbus interface is configured to receive the one or more Modbus commands from a device remote from the PLC.

14. A system comprising:
a PLC in accordance with claim 1; and
a device remote from the PLC and configured to transmit the one or more Modbus commands to the Modbus interface of the PLC.

15. A method for programming operation of a programmable logic controller, PLC, the PLC comprising a programmable logic module, a Modbus interface and a programming module, the method comprising:
receiving, by the Modbus interface of the PLC, one or more Modbus commands, the one or more Modbus commands specifying a configuration for one or more Boolean logic operations; and
programming, by the programming module of the PLC, operation of the programmable logic module in accordance with the configuration for the one or more Boolean logic operations specified by the received one or more Modbus commands.

16. The method of claim 15, further comprising:
receiving, by a device remote from the PLC, a user input;
generating, by the device remote from the PLC, using the user input, the one or more Modbus commands; and
transmitting, by the device remote from the PLC, to the Modbus interface, the one or more Modbus commands in accordance with the Modbus protocol.

17. The method of claim 15, further comprising at least one of:
monitoring, by the PLC, a system or apparatus; or
controlling, by the PLC, a system or apparatus; wherein
the system or apparatus is remote from the PLC.

18. A machine-readable storage medium storing a program or plurality of programs arranged such that when executed by a computer system or one or more processors it/they cause the computer system or the one or more processors to:
receive one or more Modbus communications, the one or more Modbus communications specifying a configuration for one or more Boolean logic operations; and
program operation of a programmable logic controller, PLC, in accordance with the configuration for the one or more Boolean logic operations.

19. (canceled)
